(19) United States
(12) Patent Application Publication
(10) Pub. No.: US 2007/0262217 A1
(43) Pub. Date: Nov. 15, 2007

(54) Sucking disc apparatus

(76) Inventors: Leland Wang, Walnut, CA (US); Chun-Chen Lin, Yilan City (TW); Fu-Ching Wang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/433,438

(22) Filed: May 15, 2006

(51) Int. Cl. F16B 47/00

(52) U.S. Cl. 248/205.5

(57) ABSTRACT

A sucking disc apparatus includes a body, a sucking disc, a pulling rod, a spring, and an operation element. The body includes a pressing part and a protruding part protruding from the top of the pressing part. The sucking disc is located at the bottom of the pressing part of the body. The pulling rod is located in the body and has a rectangular slot hole. The spring is located between the body and the sucking disc. The operation element includes an operation part and a cam part. The operation element is pivoted with the protruding part of the body via a pivoting shaft. Thereby, the rectangular slot hole is hidden in the sucking disc apparatus, the appearance of the sucking disc apparatus is not affected, and muck does not drop into the rectangular slot hole so that the movement of the sucking disc is smooth.

### BACKGROUND OF THE INVENTION

1. Field of the Invention

The present invention relates to a sucking disc apparatus. In particular, this invention relates to a sucking disc apparatus that generates a strong vacuum sucking force so as to fasten a heavy device (such as a satellite navigating device, a PDA, or a cell phone etc.) on to a smooth surface.

2. Description of the Related Art

There are currently a variety of sucking discs available for consumers. Sucking discs are divided into two types. Then first kind is a simple sucking disc. When the sucking disc is used, the sucking disc is pressed to exhaust air so as to stick on a smooth surface. The second kind is a sucking disc having a rod for driving the sucking disc upward. When the sucking disc is used, the sucking disc is pressed to exhaust air and the sucking disc moves upward to generate a vacuum sucking force so that the sucking disc sucks steadily on the smooth surface. Because this sucking disc has a stronger vacuum sucking force, the sucking disc can be used for fastening heavy devices, such as satellite navigating devices, PDAs, or cell phones etc.

A sucking disc apparatus of the prior art is disclosed, as shown in FIGS. 1 and 3. The sucking disc apparatus 9 includes a body 91, a sucking disc 92, a spring 93, and an operation element 94. The body 91 is hollow. On the top of the body 91, a linking rod 95 is connected with a supporting board 96. The supporting board 96 is used for fastening a holding device (not shown in the figure) that is used to hold a device, such as a satellite navigating device, etc. The sucking disc 92 is made of rubber. The sucking disc is located at the bottom of the body 91. A pulling rod 97 protrudes from the center of the top of the sucking disc 92. The pulling rod 97 is installed in the body 91 and can move upward and downward along the body 91. The spring 93 is located between the top of the pulling rod 97 and the body 91 for providing a recovering force to make the pulling rod move downward. The operation element 94 is pivoted with the pulling rod 97 via a pivot shaft 941 so that the operation element 94 can rotate by using the pivoting shaft 941 as a rotation shaft. On one end of the operation element 94, there is a cam part 942. The cam part 942 pushes and contacts the body 91. When the operation element 94 is rotated, the cam part 942 is utilized to make the pulling rod 97 move upward so as to make the sucking disc move upward. The pivoting shaft 941 fits in with the corresponding rectangular slot hole 911 of the body 91 to make the pulling rod 97 move upward and downward. When the sucking disc apparatus is used, the sucking disc 92 is pressed to exhaust the air, then the operation element 94 controls the sucking disc to move upward so as to generate a vacuum sucking force. Thereby, sucking disc stably sticks on the smooth surface.

However, the rectangular slot hole 911 of the sucking disc apparatus of the prior art is located on the body 91. The rectangular slot hole 911 is exposed to the external environment. The appearance of the sucking disc apparatus is affected, and muck and foreign matter easily drop into the rectangular slot hole 911 so as to affect the operation of the pivoting shaft 941 and the pulling rod 97. The movement of the sucking disc 92 is not smooth.

### SUMMARY OF THE INVENTION

One particular aspect of the present invention is to provide a sucking disc apparatus. The rectangular slot hole is located on the pulling rod to make the rectangular slot hole be hidden inside the sucking disc apparatus. Therefore, the appearance of the sucking disc apparatus is not affected, and muck and foreign matter do not drop into the rectangular slot hole so as to make the operation of the pivoting shaft and the pulling rod smoother. The movement of the sucking disc is smooth.

The sucking disc apparatus includes a body, a sucking disc, a pulling rod, a spring, and an operation element. The body includes a pressing part and a protruding part and the protruding part protrudes from the top of the pressing part. The sucking disc is located at the bottom of the pressing part of the body. The lower end of the pulling rod is connected with the center of the sucking disc. The pulling rod is located in the body and can move upward and downward along the body and the pulling rod has a rectangular slot hole. The spring is located between the body and the sucking disc. The operation element includes an operation part and a cam part. The operation element is pivoted with the protruding part of the body via a pivoting shaft. The pivoting shaft passes through the rectangular slot hole of the pulling rod. The cam part pushes and contacts the pulling rod.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a side view of the sucking disc apparatus of the prior art;

FIG. 2 is a cross-sectional view of the sucking disc apparatus of the prior art;

FIG. 3 is an exploded perspective view of the sucking disc apparatus of the present invention;

FIG. 4 is an assembled perspective view of the sucking disc apparatus of the present invention;

FIG. 5 is a cross-sectional view of the sucking disc apparatus of the present invention; and

FIG. 6 is a perspective view of the operation status of the sucking disc apparatus of the present invention.

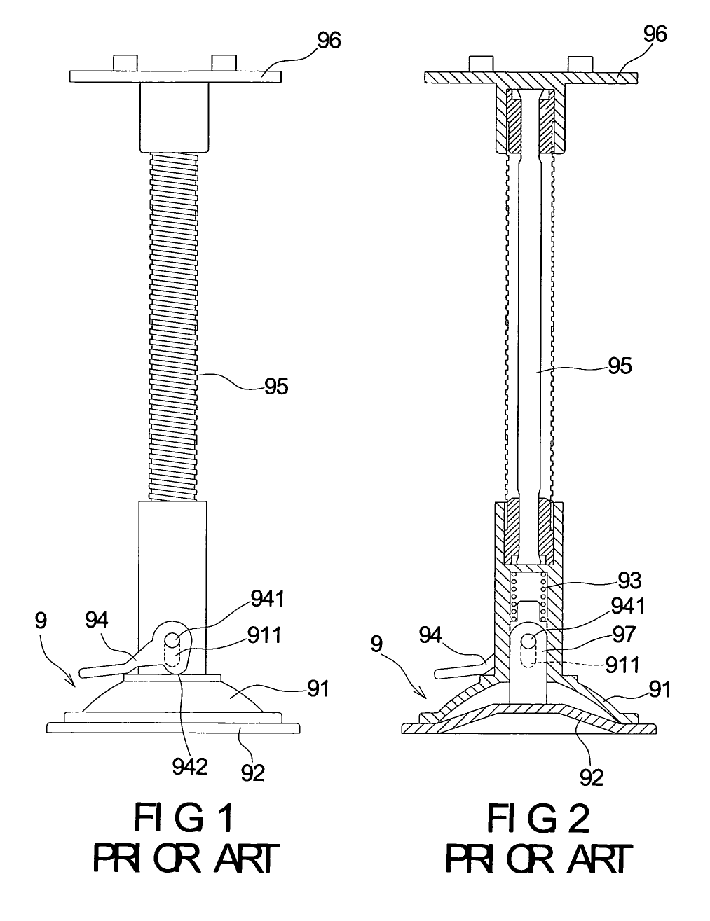

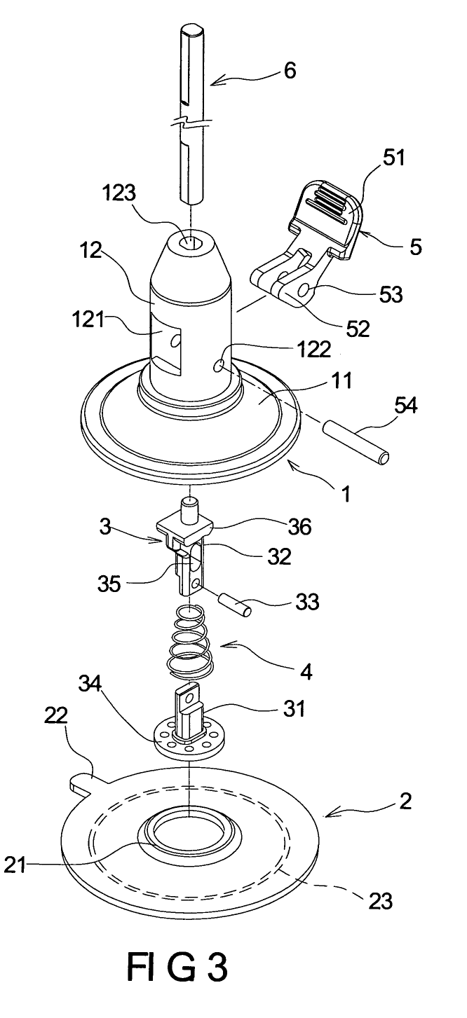

### DETAILED DESCRIPTION OF THE PREFERRED EMBODIMENTS

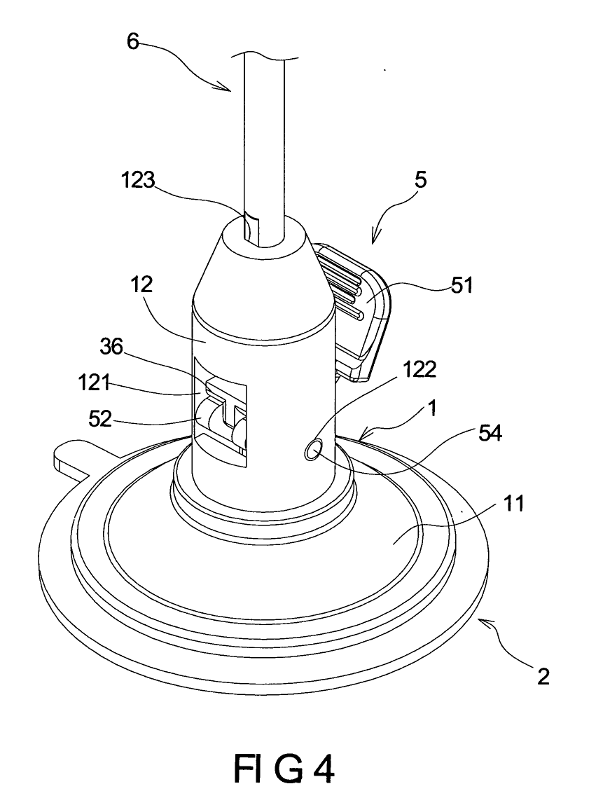

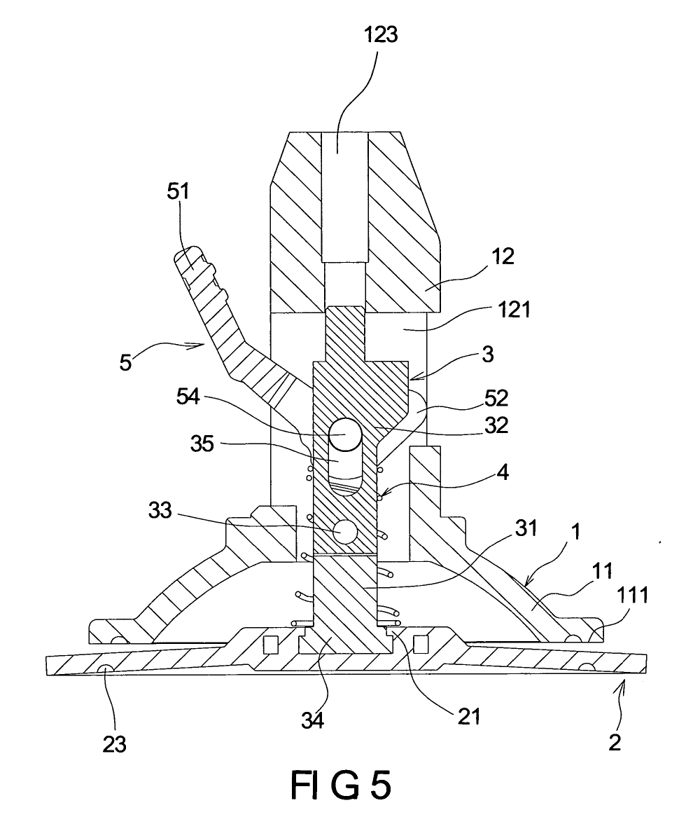

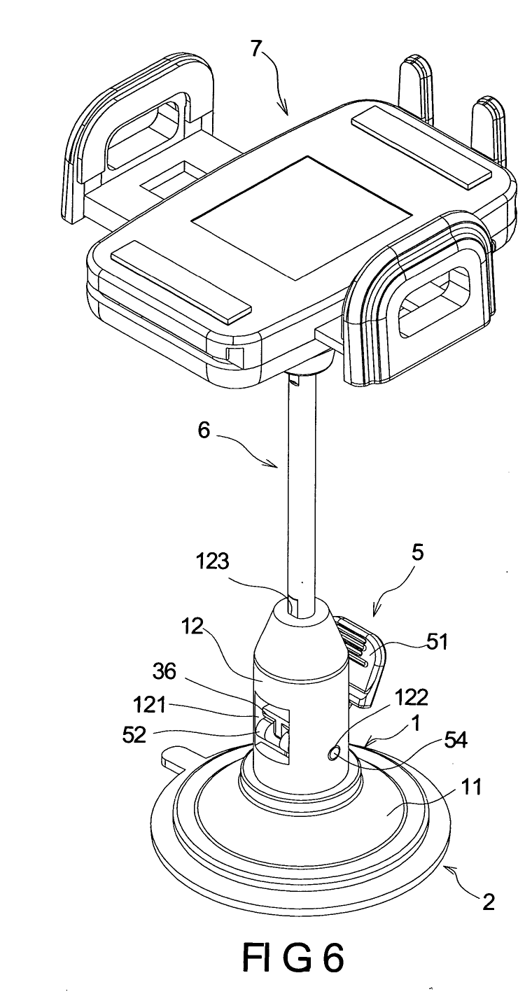

Reference is made to FIGS. 3, 4 and 5. The sucking disc apparatus includes a body 1, a sucking disc 2, a pulling rod 3, a spring 4, and an operation element 5. The body 1 is made of plastic materials. The body 1 includes a pressing part 11 and a protruding part 12. The pressing part 11 has a hollow arc shape. On the bottom of the pressing part 11, there is a pressing surface 111 having a circular shape. The protruding part 12 protrudes from the center of the top of the pressing part 11. The protruding part 12 has a hollow-column shape. There is a receiving space 121 formed in the inner of the protruding part 12 for receiving the operation element 5. At the two sides of the protruding part 12, there are two first pivoting holes 122 that correspond to each other for pivoting with the operation element 5. On the upper end of the protruding part 12, there is a linking hole 123 that is plugged with a linking rod 6. Another end of the linking rod 6 is used for connecting to a holding device 7 (as shown in FIG. 6) and the holding device 7 is used for holding a device, such as a satellite navigating device, a PDA, or a cell phone etc.

The sucking disc 2 is made of rubber and has a circular-disc shape. A circular fixing base 21 protrudes from the center of the top of the sucking disc 2 for connecting with the pulling rod 3. A tongue-shaped flake 22 protrudes from the edge of the sucking disc 2 for pulling out the sucking disc 2 from the smooth surface. On the bottom of the sucking disc 2, there is a circular slot 23 used for increasing the sucking force of the sucking disc 2. The sucking disc is located below the pressing part 11 of the body 1 so that the pressing part 11 of the body 1 is adjacent to the top of the sucking disc 2.

The pulling rod 3 is located between the body 1 and the sucking disc 2. The pulling rod 3 is located in the body 1 and can move upward and downward along the body 1. In this embodiment, the pulling rod 3 comprises two elements. Alternatively, the pulling rod 3 can be implemented by an integrated element. The pulling rod 3 includes a lower rod element 31 and an upper rod element 32. The lower rod element 31 and the upper rod element 32 are connected together via a pin 33. A fixing end 34 is formed at the lower end of the lower rod element 31. The fixing end 34 is fastened to the fixing base 21 of the sucking disc 2 so that the lower end of the pulling rod 3 is fastened to the center of the top of the sucking disc 2. The upper rod element 32 has a rectangular slot hole 35. The rectangular slot hole 35 extends to a proper distance along the shaft of the pulling rod 3. On the upper end of the upper rod element 32, there is a push-contacting block 36.

The spring 4 is a compressed spring and is located at the exterior part of the pulling rod 3. The spring 4 is located between the sucking disc 2 and the body 1. The lower end of the spring 4 pushes and contacts the fixing end 34 of the pulling rod 3 and the sucking disc 2 for providing the recovering force so as to make the pulling rod 3 and sucking disc 2 move downward.

The operation element 5 includes an operation part 51 and a cam part 52 being connected with one end of the operation part 51. A second pivoting hole 53 transversely passes through the cam part 52. A pivoting shaft 54 is plugged into the first pivoting hole 122 of the protruding part 12 of the body 1, the second pivoting hole 53 of the operation element 5, and the rectangular slot hole 35 of the pulling rod 3. The pivoting shaft 54 is fastened to the protruding part 12 of the body 1 for pivoting the operation element 5 to the protruding part 12 of the body 1 so that the operation element 5 takes the pivoting shaft 54 as a rotation shaft to perform a rotating operation. The cam part 52 of the operation element 5 is received in the receiving space 121 and the cam part 52 pushes and contacts the bottom of the push-contacting block 36 of the pulling rod 3. The pivoting shaft 54 fits in with the rectangular slot hole 35 of the pulling rod 3 for guiding the pulling rod 3 to move upward and downward. Therefore, the pulling rod 3 does not interfere with the pivoting shaft 54 when the pulling rod 3 is moving upward and downward.

When the sucking disc apparatus is used, the sucking disc is pressed to exhaust the air. Then, the operation element 5 controls the sucking disc 2 to move upward. When the operation element 5 is rotated, the cam part 52 is utilized to push upward the push-contacting block 36 so as to make the pulling rod 3 and the sucking disc 2 move upward. The top of the sucking disc 2 is pushed and contacted by the pressing surface 111 of the pressing part 11 of the body 1. The rising sucking disc 2 generates a vacuum sucking force to make the sucking disc 2 steadily stick on the smooth surface.

The rectangular slot hole 35 is located on the pulling rod 3 to make the rectangular slot hole 35 be hidden in the sucking disc apparatus. Therefore, the appearance of the sucking disc apparatus is not affected, and muck and foreign matter do not drop into the rectangular slot hole 35 so as to make the operation of the pivoting shaft 54 and the pulling rod 3 smoother. The movement of the sucking disc 2 is smooth.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A sucking disc apparatus, comprising:
a body having a pressing part and a protruding part, wherein the protruding part protrudes from the top of the pressing part;
a sucking disc located at the bottom of the pressing part of the body;
a pulling rod, wherein a lower end of the pulling rod is connected with the center of the sucking disc, and the pulling rod is located in the body and moves upward and downward along the body and the pulling rod has a rectangular slot hole;
a spring located between the body and the sucking disc; and
an operation element having an operation part and a cam part, wherein the operation element is pivoted with the protruding part of the body via a pivoting shaft, and the pivoting shaft passes through the rectangular slot hole of the pulling rod and the cam part pushes and contacts the pulling rod.

2. The sucking disc apparatus as claimed in claim 1, wherein a circular pressing surface is formed on the bottom of the pressing part of the body, and the pressing surface pushes and contacts the top of the sucking disc when the suck disc is moving upward.

3. The sucking disc apparatus as claimed in claim 1, wherein a receiving space is formed in the inner part of the protruding part of the body, and the cam part of the operation element is received in the receiving space.

4. The sucking disc apparatus as claimed in claim 1, wherein the protruding part of the body has a first pivoting hole and the operation element has a second pivoting hole, and the pivoting shaft is plugged into the first pivoting hole of the protruding part of the body and the second pivoting hole of the operation element and the pivoting shaft is fastened to the protruding part of the body.

5. The sucking disc apparatus as claimed in claim 1, wherein a linking hole is located on the upper end of the protruding part, and the linking hole is plugged with a linking rod and another end of the linking rod is connected with a holding device.

6. The sucking disc apparatus as claimed in claim 1, wherein a circular fixing base protrudes from the center of the top of the sucking disc and the a fixing end is formed at the lower end of the pulling rod, and the fixing end is fastened to the fixing base.

7. The sucking disc apparatus as claimed in claim 1, wherein the pulling rod is made of an integrated element.

8. The sucking disc apparatus as claimed in claim 1, wherein the pulling rod comprises two elements, including a lower rod element and an upper rod element, and the lower rod element is connected with the upper rod element via a pin.

9. The sucking disc apparatus as claimed in claim 1, wherein a push-contacting block is formed at the upper end of the pulling rod, and the cam part of the operation element pushes and contacts the bottom of the push-contacting block.

10. The sucking disc apparatus as claimed in claim 1, wherein a circular slot is formed at the bottom of the sucking disc.
